(19) United States
(12) Patent Application Publication
(10) Pub. No.: US 2008/0289212 A1
(43) Pub. Date: Nov. 27, 2008

(54) Clothes Dryer

(76) Inventors: Jung-Wook Moon, Gyeongsangnam-Do (KR); Hyun-Uk Lee, Gyeongsangnam-Do (KR); Seung-Phyo Ahn, Gyeongsangnam-Do (KR); Chang-Woo Son, Busan (KR); Dong-Joo Han, Gyeongsangnam-Do (KR); Byeong-Jo Ryoo, Gyeongsangnam-Do (KR)

Correspondence Address: KED & ASSOCIATES, LLP, P.O. Box 221200, Chantilly, VA, 20153-1200, US

(21) Appl. No.: 12/094,874

(22) PCT Filed: Nov. 20, 2006
(86) PCT No.: PCT/KR2006/004882

§ 371 Date: May 23, 2008

(30) Foreign Application Priority Data
Nov. 24, 2005 (KR) 10-2005-0113144
Dec. 17, 2005 (KR) 10-2005-0124928

(51) Int. Cl. F26B 3/34; F26B 11/02

(52) U.S. Cl. 34/267; 34/108

(57) ABSTRACT

A clothes dryer includes a cabinet, a drum rotatably installed within the cabinet and a heating unit that heats the drum. Because the heating unit heats the drum itself, heat generated from the heating unit is transferred to the outer surface of the drum, passes through the interior of the drum according to thermal conduction and then heats the clothes, target items to be dried, so that temperature of the entire clothes are uniformly increased to accelerate evaporation of moisture of the target items to be dried.

### TECHNICAL FIELD

The present invention relates to a clothes dryer and, more particularly, to a clothes dryer capable of uniformly and quickly drying the clothes and reducing energy consumption in drying the clothes.

### BACKGROUND ART

The clothes dryer typically includes a rotatable drum and dries a dry item with air of high temperature. The clothes dryer can be divided into an exhaust type clothes dryer and a condensing type clothes dryer depending on how air with moisture generated while drying a target item to be dried is processed. The exhaust type clothes dryer discharges air with moisture and the condensing type clothes dryer condenses air with moisture to deprive of the moisture from the air and circulates the moisture-free air therein.

FIG. 1 shows the sectional structure of the related art exhaust type clothes dryer. As shown, the clothes dryer includes a cabinet 10 having a door 11 formed at a front side thereof, a drum 12 rotatably installed within the cabinet 10, a hot wind guiding duct 13 that guides hot wind into the drum 12, a hot wind discharge duct 14 that discharges hot wind which has passed through the interior of the drum 12, and a blow fan 15 that sucks external air and discharging it.

An opening 16 is formed at a front surface of the cabinet 10 in order to allow the laundry to be inputted into the drum 12 or taken out of the drum 12. The drum 12 is rotated at a low speed by means of a motor 17 installed at the bottom within the cabinet 10. The motor 17 simultaneously drives the drum 12 and a blow fan 15, for which a driving shaft 18 of the motor 17 extends to both sides of the motor 17 and one end of the driving shaft 18 is connected with the blow fan 15 and the other end of the driving shaft 18 is connected with a pulley 19 that rotates the drum 12. A belt 20 installed to cover the drum 12 is connected with the pulley 19.

The hot wind discharge duct 14 is disposed between a lower portion of the front side of the drum 12 and the blow fan 15. A filter 21 is installed at one end of the hot wind discharge duct 14 to filter out debris such as nap included in hot wind which has passed through the drum 12. An exhaust duct 22 is combined with an outlet of the blow fan 15. The exhaust duct 22 is formed as a cylindrical pipe and its opening end extends to outside of the cabinet 10. An opening and closing valve 23 is installed at the opening end of the exhaust duct 22, in order to open the exhaust duct 22 when the blow fan 15 is operated, and close the exhaust duct 22 when the blow fan 15 is not operated, to thus prevent an introduction of debris from outside.

A heater 30 is installed at an upper portion of the hot wind guiding duct 13. As the blow fan 15 and the drum 12 are rotated according to rotation of the motor 17, external air passes through the heater 30 so as to be heated and then introduced to the drum 12 through the hot wind guiding duct 13.

Accordingly, the wet laundry placed in the drum 12 is dried by the hot wind, and upon passing through the drum 12, the hot wind is externally discharged through the hot wind discharge duct 14 and the exhaust duct 22.

In general, in the exhaust type dryer, an intake duct and an exhaust duct are connected with the rotatable drum installed within the cabinet, and the heater is installed within the intake duct.

As air outside the dryer is introduced to the intake duct according to the driving of the fan, it is heated to have high temperature by the heater, and in this case, the heating temperature reaches up to about 100° C. As the air with high temperature is introduced to the drum within the dryer, the target item to be dried in the drum is dried. During the drying process, the air with the high temperature takes moisture from a target item to be dried and the air having high moisture is externally discharged through the exhaust duct.

The related art clothes dryer in which heat is transferred to the introduced air by using the heater can shorten the overall dry time by quickly heating air by using the heater and can be fabricated with a large capacity, but is disadvantageous in that because the introduced air is heated by the heater, much energy is consumed. In particular, because the target item to be dried is dried with air with temperature of 100° C. or higher, the target item can be damaged during the drying process according to its material. In addition, although the drum is rotated, air with the high temperature cannot be evenly applied to the target item, drying the clothes partially, resulting in a problem that the overall drying efficiency is degraded.

The condensing type clothes dryer is advantageous in that it can be fabricated as a built-in type clothes dryer without the necessity of the exhaust duct for discharging air to outside the clothes dryer and its energy efficiency is high compared with the exhaust type clothes dryer, but has shortcomings in that a dry time is long and it cannot be fabricated with a large capacity.

Therefore, a clothes dryer that may have a high energy efficiency and do not cause damage to the target item to be dried is on demand.

### DISCLOSURE OF THE INVENTION

The present invention has been made in view of the above-mentioned problem, and it is one object of the invention to provide a clothes dryer capable of having the high energy efficiency and not doing damage to a target item to be dried.

It is another object of the invention to uniformly and quickly dry the clothes within a clothes dryer and reduce energy consumption in drying of the clothes.

It is still another object of the invention to provide a clothes dryer capable of drying the clothes in various dry modes with the high energy efficiency.

An exemplary embodiment of the present invention provides a clothes dryer that may include: a cabinet; a drum rotatably installed within the cabinet; and a heating unit that heats the drum.

With such a structure, the heating unit heats the drum itself to allow heat generated from the heating unit to be transferred to an outer surface of the drum and pass through the interior of the drum according to thermal conduction to thus heat the clothes, a target item to be dried, whereby temperature of the clothes uniformly increases to accelerate evaporation of moisture of the interior of the target item to be dried. Because the moisture can be quickly discharged from the target item to be dried and then externally discharged to external air, a clothes drying process can be promptly performed, and because the moisture of the target item to be dried is not evaporated only with air introduced into the drum, temperature of the air introduced into the drum can be controlled to be low to thus prevent damage of the target item to be dried.

In other words, comparatively, in the related art clothes dryer, in order to dry the clothes, the air with high temperature is allowed to contact with the target item to be dried. Thus, when temperature of the air introduced into the drum is increased for a quick drying, the target item to be dried can be damaged by the air with the high temperature, and although the drum is rotated in order to increase the contact area between the air with the high temperature and the clothes, the clothes contacting with the inner surface of the drum is separated by a considerably certain distance from the flow path of the air with the high temperature, making the clothes contacting with the air with the high temperature excessively dried to be damaged while clothes distanced from the flow path of the air with the high temperature remain un-dried.

However, in the present invention, the drum itself is heated, so although time is taken and energy is required for heating the drum at an initial stage, heat can be easily transferred from the drum itself to the clothes that can hardly contact with the air with the high temperature, and thus the target items can be dried entirely. In particular, a partial drying phenomenon that drying of the clothes by 20%˜50% is delayed because a large amount of the clothes mass into a lump can be basically prevented, so the entire dry efficiency can be improved, and because temperature of air blowing toward the drum can be lowered not to damage the clothes during the drying process.

The rotating drum can be heated according to convection current by using the heating unit and the blow fan, and in the present invention the drum is heated by radiation for the sake of convenience of installation.

In this case, in order to prevent a loss of heat of the heating unit that goes to the opposite side of the drum, a reflection plate is formed between the heating unit and an inner surface of the cabinet so that heat of the heating unit radiated to the opposite side of the drum can heat the drum through the reflection plate.

The heating unit can be one of a halogen lamp, a far infrared ray lamp and a heat line.

The cabinet is commonly formed in a hexagonal shape in consideration of an installation space. Accordingly, the internal space of the cabinet is formed in the hexagonal shape, so there is a space including corner regions between the cabinet and the cylindrical drum. Meanwhile, in order to enhance the efficiency of radiation thermal conduction, it is more advantageous if the distance between the drum and the heating unit is minimal, and preferably, the heating unit is installed to face the drum. Thus, preferably, the heating unit is installed to face the drum at the hexagonal corner portions in terms of heating efficiency and space efficiency.

The drum is made of metal (or metallic material) having high thermal capacity, and is formed in a double-layered manner with an air gap therebetween, which thus allows heat to be retained in the drum for a prolonged period of time.

The clothes dryer according to the present invention includes a far infrared radiation heater as the heating unit positioned to face the rear side of the drum, so the drying activity of the target item to be dried can be smoothly performed and damage of the target item to be dried can be prevented. For reference, the far infrared ray is an infrared ray having a slightly long wavelength that goes beyond a microwave. Light is divided from the microwave to gamma rays according to intensity and wavelength and the infrared ray has a slightly higher energy than the microwave, namely, radiowave of 2 GHz˜3 GHz, and has a long wavelength to quickly absorb heat, and because the infrared ray includes many microwaves that quickly affect water molecules, it can quickly supply energy to water molecules to warm water for a quick evaporation. Thus, in the present invention, the far infrared ray can be effectively used to dry the target item to be dried.

In addition, in the present invention, the clothes dryer adopts a heat pump system as an additional heating unit that heats the drum. Thus, a heat exchanger of the heat pump system supplies air with an increased temperature to an air introduction path to dry the target item to be dried together with the far infrared radiation heater to thus provide drying algorithms in various modes.

According to the present invention, the clothes dryer includes the cabinet; the drum rotatably installed within the cabinet; and the heating unit that heats the drum. Thus, by heating the drum with the heating unit, a target item to be dried that does not directly contact with an air flow path of high temperature can receive heat from the heated drum and evenly and quickly dried with high dry efficiency.

In addition, by heating the drum that receives the target item to be dried, the dry efficiency can be improved, and by lowering temperature of air supplied to remove moisture in the interior of the drum, the possibility that the target item to be dried such as clothes is damaged by air with high temperature supplied to the drum can be prevented.

Moreover, by preventing a partial non-dried state of the target item to be dried, moisture of the target item to be dried can be quickly discharged in spited of the necessity of additional energy for heating the drum, so the amount of energy consumption required for drying the target item to be dried can be reduced.

Furthermore, by using the far infrared radiation heater installed at the rear side of the drum as the heating unit, the target item to be dried can be actively dried without being damaged.

Also, because the heat pump system is used together as the additional heating unit, various types of dry modes can be possibly used to thus extend selectivity of clothes drying of users.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view of a clothes dryer according to the related art;

FIG. 2 is a partial cut-out perspective view of a clothes dryer according to a first exemplary embodiment of the present invention;

FIG. 3 is a schematic view for explaining an operational principle of FIG. 2;

FIG. 4 is a side sectional view showing a clothes dryer according to a second exemplary embodiment of the present invention;

FIG. 5 is a perspective view of a clothes dryer according to a third exemplary embodiment of the present invention;

FIG. 6 is a schematic view for explaining an operational principle of FIG. 5; and

FIG. 7 is a perspective view of a clothes dryer according to a fourth exemplary embodiment of the present invention.

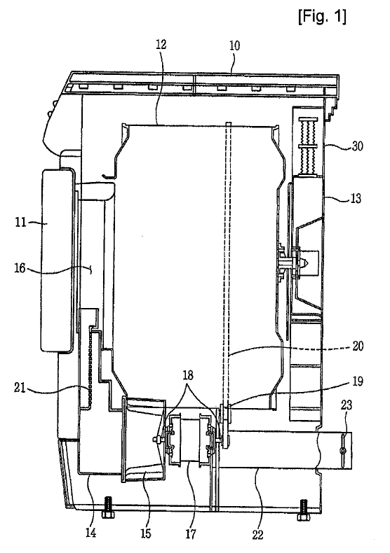

### MODES FOR CARRYING OUT THE PREFERRED EMBODIMENTS

A clothes dryer according to exemplary embodiments of the present invention will now be described in detail with reference to the accompanying drawings.

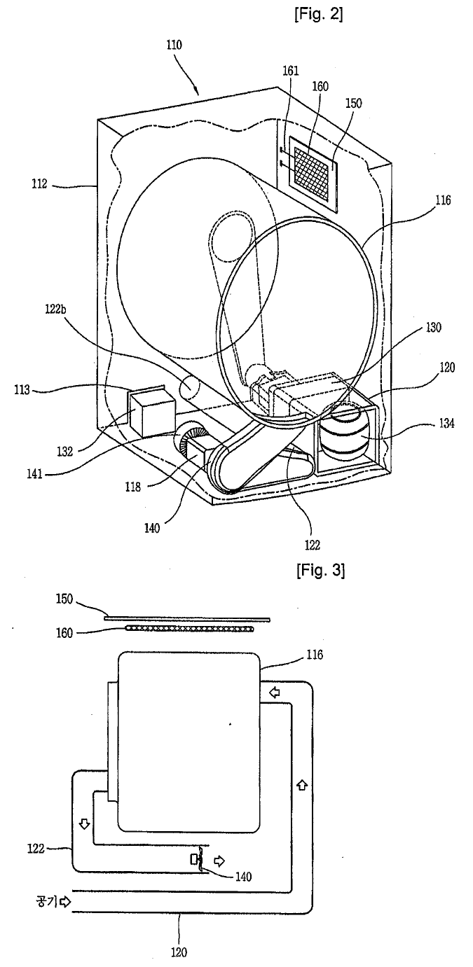

FIG. 2 is a partial cut-out perspective view of a clothes dryer according to a first exemplary embodiment of the present invention, and FIG. 3 is a schematic view for explaining an operational principle of FIG. 2.

With reference to FIGS. 2 and 3, a clothes dryer according to a first exemplary embodiment of the present invention includes a cabinet 110 having a rectangular parallelepiped shape and having a receiving part therein, a drum 116 rotatably installed within the cabinet 110, a first air flow path 120 that supplies intake air to the drum 116, a second air flow path 122 that exhausts air with moisture taken from the clothes in the drum 116, a first heat exchanger 130 formed as a condenser within the first air flow path 120 in order to heat intake air, a blow fan 140 formed within the second air flow path 122 in order to exhaust air from the drum 116, a hot wire 160 formed as a heating unit at an outer side of the drum 116 in order to radiate and heat the drum 116, and a reflection plate 150 that is formed between the hot wire 160 and an inner surface of the cabinet 110 and reflects heat leaked from the hot wire 160 to heat the drum 116.

The cabinet 110 is made of iron in the rectangular parallelepiped shape 112 for the sake of installation and includes rectangular parallelepiped space therein.

The drum 116 is installed in a cylindrical shape within the cabinet 110 such that it is rotated centering around an axis substantially parallel to a bottom surface of the cabinet 110. The first air flow path 120 through which the intake air flows is connected with one side of the drum 116 and the second air flow path 122 through which an exhaust air flow is connected with the other side of the drum 116. An outer circumferential surface of the drum is connected with a driving shaft of the motor 118 in order to receive power so as to be rotated.

The first air flow path 120 may not be exposed to outside of the cabinet 110, while an outlet 123 of the second air flow path 122 is preferably exposed to outside of the cabinet 110. The form of the first and second air flow paths 120 and 122 is not particularly limited, and a direction or a position of each parts constituting the flow paths can be changed suitably according to the internal space of the cabinet 110.

The first heat exchanger 130 is installed as the condenser at the first air flow path 120 to heat air to be introduced to the first air flow path 120 so that air having temperature increased to above 50° C., preferably, temperature of about 50° C.˜60° C., can be introduced into the drum 116.

An evaporator as the second heat exchanger 132 is installed at one side within the cabinet 110. The first and second heat exchangers 130 and 132 form a thermodynamical cycle (steam compression cycle), for which a compressor 134 and an expansion mechanism (not shown) are included in the cabinet 110. The compressor 134 and the expansion mechanism (not shown) are installed at a lower portion of the drum 116, and the first and second heat exchangers 130 and 132 are connected by a pipe (not shown) to form a closed loop. The steam compression cycle works as a heat pump over air flowing through the first air flow path 130.

In particular, the compressor 134 is installed at the side of an entrance 120a of the first air flow path and provides its self-generated heat to the air introduced through the entrance 120a, to thus aid the heating of the first heat exchanger 130 with respect to the introduced air.

Accordingly, the heating effect of the introduced air is doubled while a cooling effect of the compressor 134 can be obtained, so the overall efficiency of the steam compression cycle system can be improved.

The blow fan 140 is installed at the second air flow path 122. The blow fan 140 receives a rotating force from the driving unit 118 and generates an air flow discharged to outside through the second air flow path 122 after passing through the drum 116 from the first air flow path 120.

An auxiliary fan 141 is mounted at the other side of the motor 118. The auxiliary fan 141 prevents the motor 118 from overheating. The second heat exchanger 132 is installed in line with the auxiliary fan 141 so that when the air flow generated from the auxiliary fan 141 passes through the second heat exchanger 132, its temperature can be lowered to further improve the cooling efficiency.

An opening 113 is formed on the cabinet 110 at a rear side of the second heat exchanger 132, serving as an outlet of the air which has cooled the second heat exchanger 132. The heating unit 160 that heats the rotating drum 116 is installed spaced apart in a circumferential direction from the drum 116, and the reflection plate 150 that reflects heat of the heating unit 160 to the drum 116 is installed at the opposite side that does not faces the drum 116.

With such a structure, the heating unit 160 heats the drum 116 itself by radiation. Accordingly, the clothes that are placed at a portion where the clothes can hardly contact with the air having the high temperature can be easily dried by heat transferred from the interior of the heated drum.

Accordingly, the clothes can be prevented from being partially dried. As the heating unit 160, a hot wire, a halogen lamp, a far infrared ray lamp or a far infrared radiation heater, etc. can be used.

The operational principle of the clothes dryer according to the first exemplary embodiment of the present invention will now be described.

With reference to FIGS. 2 and 3, when a user presses an operational switch (not shown), the motor 118 rotates the drum 116. Then, simultaneously, power is applied to the heating unit 160 and heat is directly transferred to the drum from the heating unit 160 or reflected by the reflection plate 150 and then transferred to the drum 116. Accordingly, the drum 116 itself is heated.

At the same time, the blow fan 140 is rotated to generate a suction force and air outside the dryer is introduced into the entrance 120a of the first air flow path 120. In this case, heat exchanging is performed with the air introduced from the condenser 130, namely, the first heat exchanger 130, so the air having an increased temperature to be supplied to the drum 116 through the first air flow path 120 is introduced in a temperature-increased state into the drum 116.

In this case, in order not to cause a direct damage to the clothes, temperature of the air supplied through the first air flow path 120 is controlled to be within a certain temperature range, i.e., about 50° C. For this purpose, a temperature sensor (not shown) is provided at the first air flow path 120.

The air entering the drum is maintained at about 50° C.˜60° C., so that it can smoothly performing drying on the target item to be dried in the drum 116 without doing damage thereto. The air in the high temperature state introduced into the drum 116 takes moisture from the target item to be dried and flows out of the drum in a state of having high moisture. The air flowing out of the drum is discharged to outside of the cabinet 110 through the second air flow path 122.

Meanwhile, heat generated from the heating unit 160 is radiated to the surface of the rotating drum 116 or reflected by the reflection plate 150 and then transferred in a radiation form upon being reflected by the reflection plate 150, which passes through the interior of the drum 116 by thermal conduction to heat the clothes, the target item to be dried. Accordingly, temperature of the overall clothes increases uniformly to accelerate evaporation of moisture of the clothes. In this case, moisture generated in the interior of the drum is discharged to outside via the second air flow path 122 as the blow fan 140 is driven. Although temperature of the dry air supplied through the first air flow path 120 is lowered to about 50° C. by the heating unit 160, because the drum 116 itself is heated, the clothes, the target item to be dried, cannot be damaged and quickly dried. In order to improve the energy efficiency, the drum 116 can be heated to about 40° C. by the heating unit 160 and then rotated to allow air to be introduced therein.

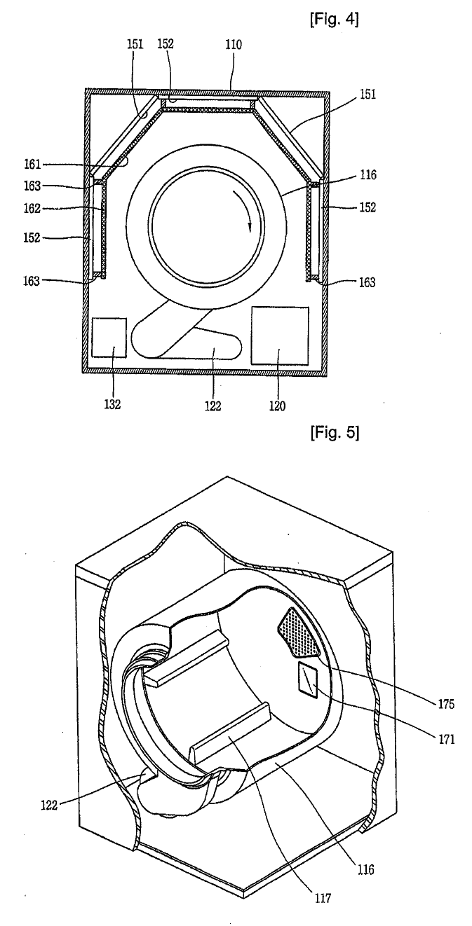

FIG. 4 is a side sectional view showing a clothes dryer according to a second exemplary embodiment of the present invention. The arrow shown in FIG. 4 indicates a rotational direction of the drum. With reference to FIG. 4, a plurality of heating units 161 and 162 are installed to cover a portion of the drum 116 in order to heat the drum 116. At this time, the heating units 161 and 162 are arranged to face the outer circumferential surface of the drum 116 to heat the drum 116 while minimizing leakage of heat generated from the heating units 161 and 162. Heat resistant reflection plates 151 and 152 are installed on a rear surface of the heating units 161 and 162 in a state that they are spaced apart by a certain distance. The reflection plates 151 and 152 reflect heat generated by the heating units 161 and 162 that direct to the inner surface of the cabinet 110 to thus help heat the drum 116. In order to prevent the reflection plates 151 and 152 from being thermally deformed by the heat generated from the heating units 161 and 162, mounting units 163 made of heat resistant ceramic material are insertedly installed between the heating units 161 and 162 and the reflection plates 151 and 152 in order to fix the heating units 161 and 162 in a state of separating the heating units 161 and 162 and the reflection plates 151 and 152.

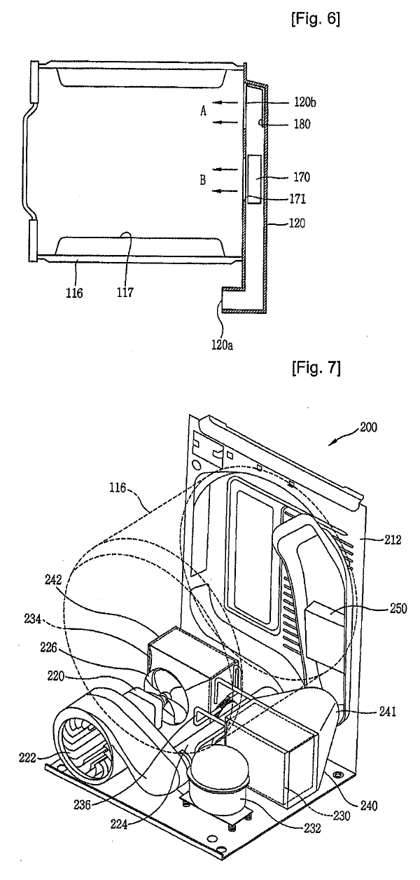

FIG. 5 is a perspective view of a clothes dryer according to a third exemplary embodiment of the present invention, and FIG. 6 is a schematic view for explaining an operational principle of FIG. 5.

With reference to FIGS. 5 and 6, a far infrared radiation heater 170 is installed at a rear side of the drum 116. The far infrared radiation heater 170 is installed at an air inlet passage whose one end is connected with the drum 116, namely, within the first air flow path.

In order to minimize damage of the target item to be dried, the far infrared radiation heater 170 does not directly contact with the drum 116. With reference to FIG. 6, the far infrared radiation heater 170 is installed at a middle portion of the first air flow path 120 and a window 171 is installed at a front side of the far infrared radiation heater 170. The window 171 prevents the far infrared radiation heater 170 from directly contacting with the target item to be dried while not interfering supplying, according to radiation, of the far infrared ray transferred from the far infrared radiation heater 170.

The window 171 can be made of any material so long as it does not interfere radiation transferring of the far infrared ray. For example, the window 171 can be made of glass or transparent heat resistant plastic.

Preferably, the window 171 is positioned at a lower portion centering around a rotational shaft of the drum 116. When the drum 116 is rotated, the target items to be dried are moved along a lift 117 protruded from the internal wall of the drum 116, but most of them are dropped according to gravity.

Thus, in order to increase the possibility of supplying of more heat to the target items to be dried, it is effective that the transparent window 117 is positioned at the lower portion of the drum 116 to which the far infrared ray is concentrated.

An outlet 120b of the first air flow path 120 is a gateway through which air having a high temperature is introduced, and preferably has a structure that at least a portion is opened. For example, a platy structure 175 having a plurality of through holes can be used. Air having temperature increased by heat supplied by the far infrared radiation heater 170 can be supplied to the drum 116 based on a natural convection or convection according to a forcible flow by the blow fan 140 (refer to FIG. 3) through the structure 175.

In this manner, the far infrared radiation heater can simultaneously supply heat according to radiation through the window 171 and heat according to convection through the first air flow path 120. Thus, the dry efficiency can be improved without causing damage to the target item to be dried. The arrows A and B in FIG. 6 indicate a heat supply according to convection and heat supply according to radiation.

A radiation plate 180 is installed where the drum 116 and the first air path 120 are connected. The heat radiation plate 180 allows the heat transferred in the upward direction perpendicular to the window 171 to effectively enter the interior of the drum 116. Preferably, the radiation plate 180 is made of a metal material that can reflect the far infrared ray. Because the radiation plate 180 is installed to be sloped at an end of the first air flow path 120, the far infrared ray can be more effectively transferred into the drum 116.

With the far infrared radiation heater 170 installed in the clothes dryer, temperature of air introduced to the first air flow path 120 increases as the air passes through the far infrared radiation heater 170, is introduced into the drum 116 to dry the clothes, and then discharged to outside of the drum 116.

Accordingly, the clothes are dried according to the convection and the radiation through the window 171, so the dry efficiency can be improved.

In addition, when a target item to be dried, which does not need to be completely dried, for example, such as a target item to be dried with wrinkles or a target item to be dried that has not undergone a washing process, needs to be simply dried, namely, when a refreshing operation is required, the far infrared heater 170 can effectively perform drying on the target item to be dried. In case of the related art clothes drier, when the refreshing operation needs to be performed on the target item to be dried, there is no any other way but to simply supply cooled air into the drum for a certain time, Comparatively, however, because the target item to be dried is less damaged by the far infrared rays, the far infrared radiation heater 170 can be actuated for a certain time to perform the operation it the refresh mode, not the complete drying operation, to smooth out wrinkles of the target item to be dried.

FIG. 7 is a perspective view of a clothes dryer according to a fourth exemplary embodiment of the present invention. With reference to FIG. 7, a clothes dryer 200 can additionally use a heat pump system as a heat source for heating the drum 116 in addition to the heating unit 160 (in FIG. 2). Accordingly, a dry mode of the clothes dryer 200 can be more diverse. The construction and installation position of the heating unit 160 has been described in the first to third exemplary embodiments of the present invention, so its description herein will be omitted.

As shown in FIG. 7, preferably, the heat pump system is installed on the bottom surface in terms of utilization of a space. That is, by installing the heat pump system on the bottom surface, an internal space of the clothes dryer 200 can be effectively used to optimize a size of the clothes dryer 200.

The heat pump system includes a compressor 232 installed at a front side of the bottom surface, a condenser 230 installed at a rear side of the compressor 232 and serving as a first heat exchanger, and an evaporator 234 installed at a rear side of a motor 220 and serving as a second heat exchanger.

An auxiliary fan 226 is mounted in front of the evaporator 234. The auxiliary fan 226 generates an air flow at the evaporator 234 or the motor 220 to thus accelerate heat exchanging of the evaporator 234 and effectively remove condensing water generated from a surface of the evaporator 234.

The condenser 230 and the evaporator 234 are covered by each housing and positioned on each separate flow path. The condenser 230 is positioned at the first air flow path formed by the first housing 240 and one end 241 of the first housing is connected with an air inlet of the drum 116. The evaporator 234 is positioned at the second air flow path formed by the second housing 242. A rear end of the second housing 242 corresponds to a rear surface of the cabinet 112 (in FIG. 2) of the clothes dryer and preferably has an opened structure to allow air heat-exchanged with the evaporator 234 to be discharged externally. Components of the heat pump system are connected by a pipe 236.

The air with high temperature due to passing through the condenser 230, the first heat exchanger, is introduced to the interior of the drum 116, dries the target items to be dried (not shown), and then externally discharged through an air outlet passage 224. The disposition of each component of the heat pump system shown in FIG. 7 is an exemplary one and the components of the heat pump system can be disposed in a different manner. By using the both heat pump system and the heating unit as heat sources, various types of dry modes can be operated.

As so far described, the clothes dryer according to the present invention can be implemented for use in the home, in business, for factories, and many other applications.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A clothes dryer comprising: a cabinet; a drum rotatably installed within the cabinet; and a heating unit that heats the drum.

2. The dryer of claim 1, wherein the heating unit heats the drum according to radiation.

3. The dryer of claim 1, wherein the heating unit is installed to be spaced apart in a circumferential direction of the drum.

4. The dryer of claim 3, further comprising: a reflection plate installed between the heating unit and the cabinet.

5. The dryer of claim 3, wherein a corner region is formed at an internal space of the cabinet and the heating unit is also installed at the corner region.

6. The dryer of claim 1, further comprising: an air inflow path connected with one end of the drum, and the heating unit is installed at the air inflow path and positioned to face a rear surface of the drum.

7. The dryer of claim 1, wherein the heating unit is one of halogen lamp, a far infrared ray lamp, a hot wire and a far infrared radiation heater.

8. The dryer of claim 6, wherein the heating unit is formed as the far infrared radiation heater and a window that is installed at a front side of the far infrared radiation heater and allows far infrared rays to be transmitted therethrough.

9. The dryer of claim 7, wherein a radiation plate is installed at a portion where the air inflow path and the drum are connected with each other.

10. The dryer of claim 9, wherein the radiation plate is installed to be sloped at an end of the air inflow path.

11. The dryer of claim 1, further comprising: a heat pump system that supplies heat to the drum.
